(19) United States
(12) Patent Application Publication
(10) Pub. No.: US 2003/0105577 A1
(43) Pub. Date: Jun. 5, 2003

(54) Autonomous control of engine operation via a lookup table

(76) Inventor: Dino Bortolin, LaSalle (CA)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/010,614

(22) Filed: Dec. 5, 2001

(51) Int. Cl. G06G 7/70

(52) U.S. Cl. 701/114; 701/115

(57) ABSTRACT

A method for controlling engine operation, the method includes the steps of providing an internal combustion engine having a crankshaft, the crankshaft rotatable through an engine cycle defining a plurality of engine positions. A control unit is provided for communicating with the crankshaft. The plurality of engine positions are extrapolated with the control unit into a reduced resolution of engine positions defining a collection of data groups. Each of the collection of data groups are assigned to one of a plurality of functions defined by data bits arranged within the control unit. The corresponding function defined by the data bits is performed according to the related collection of data groups read by the control unit.

### FIELD OF THE INVENTION

The present invention relates to controlling the operation of an internal combustion engine, and more particularly to a method for controlling engine operation by dividing the engine cycle into separate groups defined by the angular position of the crankshaft and assigning each of the separate groups to specific functions defined in a lookup table residing in the engine control unit.

### BACKGROUND OF THE INVENTION

In engine control, it is necessary to perform data collection or execute control operations synchronously with the engine's angular position. The various functions which need to be performed generally do not occur with the same frequency and timing requirements. Generally, software overhead is used to perform the functions. It is desirable to reduce software functions as much as possible in order to minimize demands on the microprocessor's bandwidth. Furthermore, it is desirable to implement a strategy that controls multiple engine functions precisely and autonomously with minimum software intervention and silicon area.

### SUMMARY OF THE INVENTION

According to the first embodiment of the present invention, a method for controlling engine operation is provided. The method includes the steps of providing an internal combustion engine having a crankshaft, the crankshaft rotatable through an engine cycle defining a plurality of engine positions. A control unit is provided having a logic operator for communicating with the crankshaft. The plurality of engine positions are extrapolated with the logic operator into a reduced resolution of engine positions defining a collection of data groups. Each collection of data groups are assigned to one of a plurality of functions defined by data bits arranged within the logic operator. The engine is operated and the data groups are read with the logic operator. The corresponding function defined by the data bits are performed according to the related collection of data groups read by the logic operator.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a perspective view of an engine block.

FIG. 2 is a perspective view of an engine control unit incorporating the low resolution processor according to a first embodiment of the present invention.

FIG. 3 is a representation of the collection of data groups referred to in the low resolution processor.

FIG. 4 is a representation of a lookup table assigned for each collection of data groups used according to the first embodiment of the present invention.

FIG. 5 is a flow chart representation of the fast lock algorithm employed according to a second embodiment of the present invention.

FIG. 6 is an example of the waveform from the cam and crank sensors.

### DETAILED DESCRIPTION OF THE PREFERRED EMBODIMENTS

The following description of the preferred embodiment(s) is merely exemplary in nature and is in no way intended to limit the invention, its application, or uses.

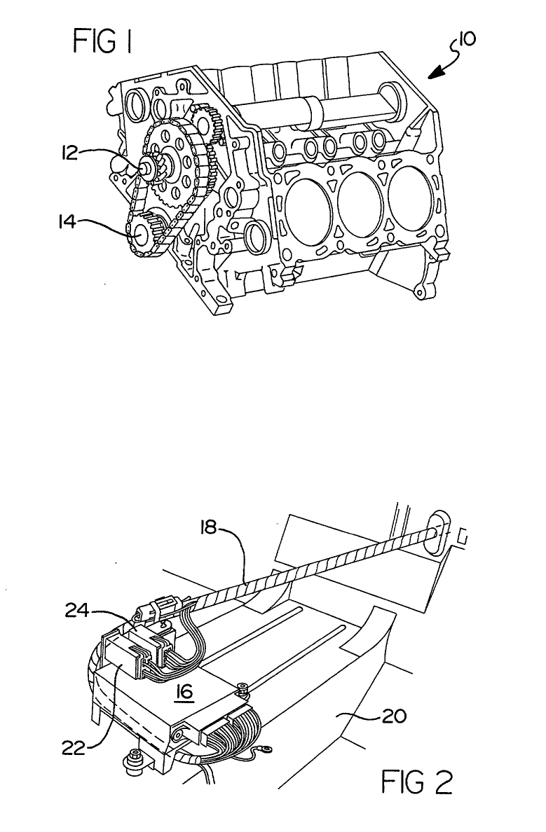

With initial reference to FIGS. 1 and 2, a camshaft 12 and crankshaft 14 are shown operatively associated with engine block 10. Engine block 10 has been removed from vehicle 20 for illustration. It will be readily appreciated by those skilled in the art that camshaft 12, crankshaft 14 and engine block 10 are merely exemplary and may comprise other variations within the scope of this invention.

Generally in a conventional four stroke engine, an electric engine controller or engine control unit must determine the angular position of the engine 10 by processing signals from sensors (not shown) on the camshaft 12 and crankshaft 14. The four stroke engine cycle repeats every two revolutions of the crankshaft 14 or 720 degrees of crankshaft 14 rotation. The crankshaft signal however, repeats every 360 degrees of crankshaft 14 rotation. The camshaft 12 rotates at half the speed of the crankshaft 14, therefore the camshaft signal repeats every 720 degrees of engine rotation. Information from the camshaft 12 is required to determine which half (or phase) of the 720 degree cycle the crankshaft 14 is in.

Turning now to FIG. 2, an engine control unit (ECU) 16 is shown. Wiring assembly 18 connects the ECU to engine 10. A power relay 22 and fuel pump relay 24 extend from the wiring assembly 18 and attach to the ECU 16. The ECU 16 performs various functions such as timing requirements, fuel concentration, emission control among others. Those skilled in the art will recognize that ECU 16 configuration is merely exemplary and may comprise other configurations which incorporate additional or fewer electrical connectors.

With continued reference to FIG. 2 and additional reference to FIGS. 3 and 4, ECU 16 incorporates a logic operator 30 having a low resolution processor 32 including a multi-bit lookup table 38 (FIG. 4). Each multi-bit entry in the table 38 corresponds to one specific engine position and defines those operations that are to take place at that point in the engine cycle. The logic operator 30 also contains other circuitry that tracks the engine angular position.

The operation of the engine control using the lookup table 38 will now be described in greater detail. Conventionally, engine position may be extrapolated to a resolution such as 0.1 degrees of crankshaft rotation. According to this invention, the engine position is determined at a lower resolution such as, for example, 10 degrees of crankshaft rotation. According to this example, each 10 degrees of crankshaft rotation comprises a data group 36, the data groups collectively illustrated as data groups 40. It will be appreciated that any resolution which evenly divides into 720 degrees may alternatively be used.

Referencing now FIGS. 1-4, as the crankshaft position reaches 0 degrees, 10 degrees, 20 degrees etc., the logic operator 30 reads the corresponding low resolution processor 32 register from the table 38. In the exemplary 11 bit table 38 shown, each bit represents a specific task to be performed. For each 10 degrees of crankshaft rotation, a table 38 is referenced and the corresponding task is determined from the categories of operations in each bit.

Turning now to FIG. 4, the bits assigned to each table 38 will be described. When the accumulate period data bit 50 is set, the time period over the last ten degrees of crankshaft 14 rotation is accumulated to a working register. When the first zero is read after a string of one or more one's, the working register is transferred to a readable register. A two bit accumulate data field 54, 56 is used to accumulate the time period over the last 10 degrees of engine rotation to one of 3 working registers. When the transfer working register bit 52 is set, the working registers are transferred to a readable register and then cleared. Two generate pulse bits 58, 60 are used to generate a pulse on an external pin (not shown), each producing a pulse of 0.1 degrees or 10 degrees respectively. When the period capture bit 62 is set, the elapsed time between the current and prior time the bit was set is stored. Interrupt bits 64, 66, 68 and 70 generate an interrupt to a microprocessor (not shown) when set. It will be readily understood by those in the art that the order and content of the bits arranged in table 38 is merely exemplary. Likewise, table 38 may also be configured to have a greater or lesser amount of bits.

According to a second aspect of the present invention, a fast lock method employed through the logic operator 30 of the ECU 16 will now be described. Once the crankshaft signal is synchronized or locked, it is not necessary to know the exact position of the engine 10 from the camshaft 12 signal, but only which phase the crankshaft 14 is in. As more edges of the camshaft 12 are read by the logic operator 30, the number of possible engine positions goes down until eventually only one remains and lock is achieved. When there are several possibilities remaining it is possible to determine the engine phase by comparing the few possible camshaft locations with the position of the crankshaft position.

Allowing for build tolerances, chain stretch and other tolerances, the engine position as found independently from the camshaft 12 and crankshaft 14 signals should agree fairly closely. Therefore, when crankshaft 14 lock is reached and the camshaft 12 is still unlocked, the camshaft 12 position should be within the range y±χ or (y+360)±χ; where y is the position determined using the crankshaft and χ is the tolerance. Once the camshaft 12 position has been narrowed down to the point where there is a potential position in one of the ranges but not the other, the crankshaft 14 phase is then known even though the camshaft 12 position has not been determined yet. The logic operator 30 waits until there are 3 or less possible marked camshaft 12 locations. If exactly one of the marked locations falls within the ranges described above, then the crankshaft 14 phase is known and the camshaft 12 is simultaneously locked using the fast lock method.

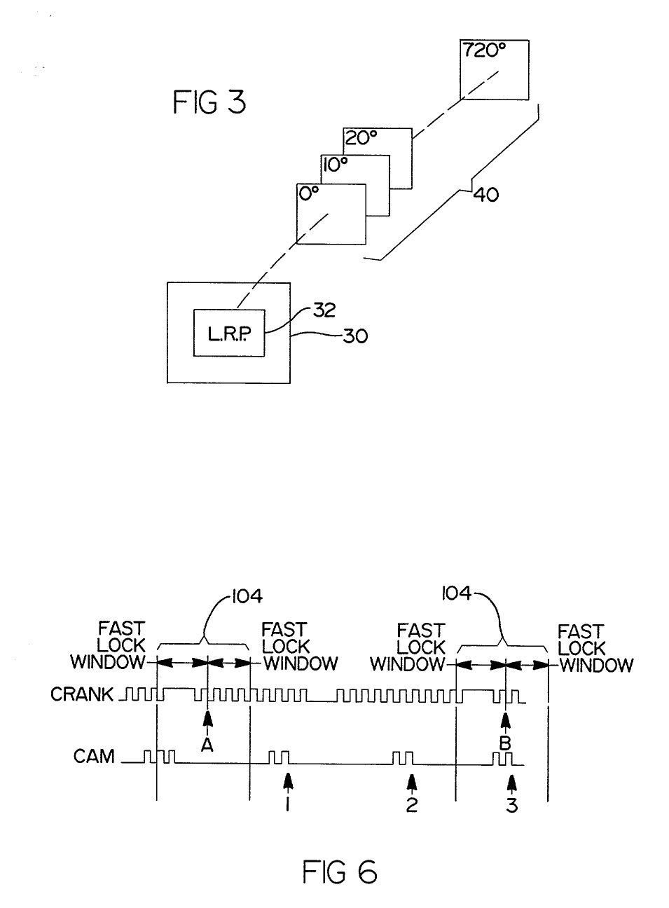

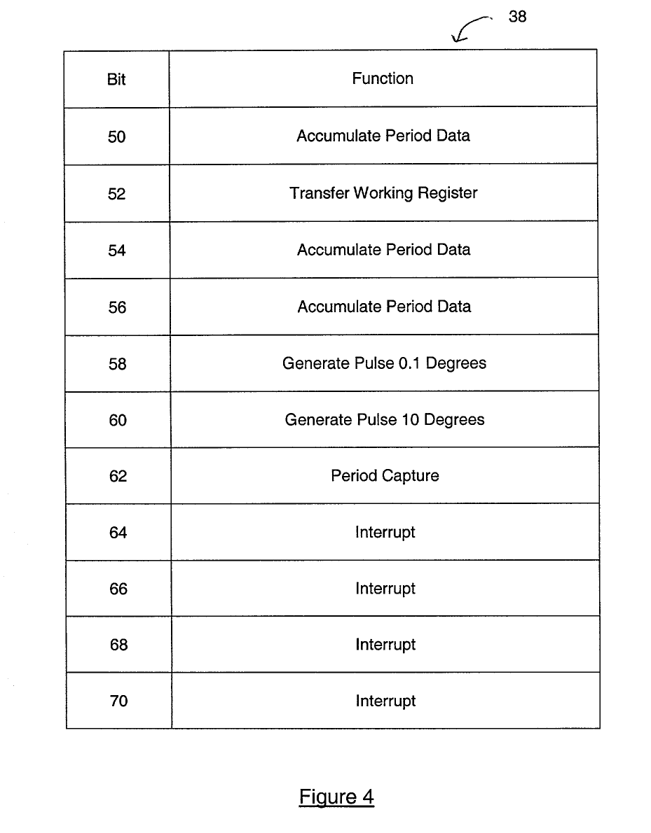

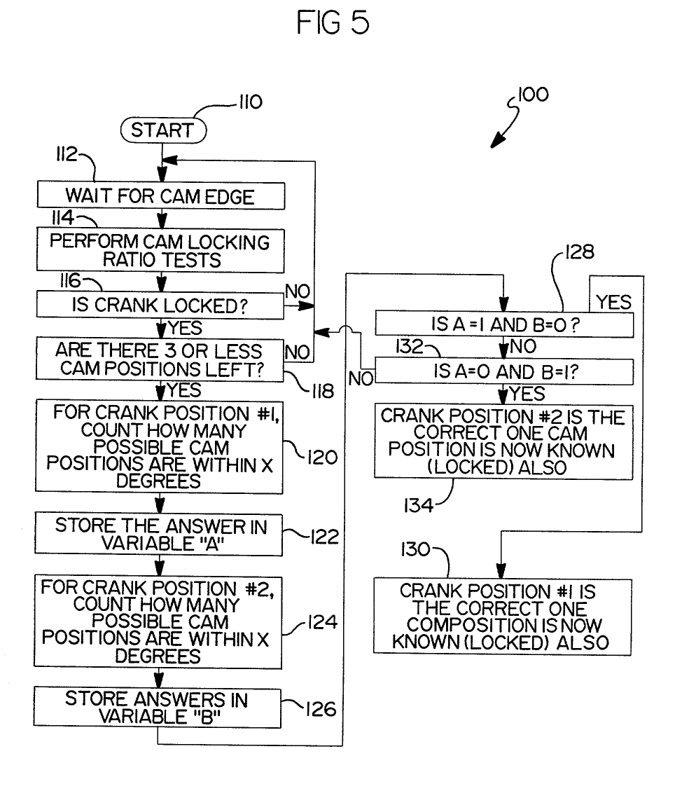

Turning now to FIGS. 5 and 6, the fast lock algorithm 100 will be described. At block 110 the algorithm is started. A cam edge is read at block 112 and the cam locking ratio tests are performed at block 114. At decision block 116 it is determined if the crankshaft 14 is locked. If the crankshaft 14 is not locked, the process returns to block 112. If the crankshaft 14 is locked, the process proceeds to decision block 118. At decision block 118 it is determined if there are 3 or less marked cam positions remaining. If not, the process returns to block 112. If there are 3 or less cam positions remaining, the process proceeds to block 120 wherein for crankshaft 14 position 1, the possible camshaft 14 positions possible within χ degrees are counted; χ degrees referring to the width or sample size of the fast lock or reference window 104. The process then proceeds to block 122 wherein the possible camshaft 12 positions determined from block 120 is stored as “A”. Next, the possible camshaft 12 positions for crankshaft 14 position 2 within χ degrees are counted at block 124 and the answer is stored as “B” at block 126. The process then proceeds to decision block 128 wherein it is determined if “A” is 1 and “B” is 0. If so, then at block 130 it is determined that crankshaft 14 position 1 is correct and the camshaft 12 position is also known and locked. If not, then at decision block 132 it is determined if “A” is 0 and “B” is 1. If not, the process returns to block 112. If so, then at block 134 it is determined that crankshaft 14 position 2 is the correct one and camshaft 12 position is also known and locked.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for controlling the engine operation of an internal combustion engine having a control unit for communicating with a crankshaft, the crankshaft rotatable through an engine cycle defining a plurality of engine positions, said method comprising the steps of;
extrapolating the plurality of engine positions with the control unit into a reduced resolution of engine positions defining a collection of data groups;
assigning each of said collection of data groups to one of a plurality of functions defined by data bits arranged within the control unit;
operating the engine;
reading said data groups with the control unit; and
performing said corresponding function defined by said data bits according to the related collection of data groups read by the control unit.

2. The method for controlling engine operation according to claim 1, wherein said data bits are arranged in the form of a lookup table.

3. The method of controlling engine operation according to claim 2, wherein said engine cycle is defined by 720 degrees of crankshaft rotation.

4. The method of controlling engine operation according to claim 3, wherein said reduced resolution includes a plurality of separate smaller groupings of crankshaft rotation which as a whole comprise 720 degrees of crankshaft rotation.

5. The method of controlling engine operation according to claim 4, wherein each of said plurality of separate smaller groupings of crankshaft rotation are of equal proportions.

6. The method of controlling engine operation according to claim 5, wherein said equal proportions include 10 degrees of crankshaft rotation.

7. The method of controlling engine operation according to claim 1, wherein one of said plurality of functions includes an interrupt function.

8. The method of controlling engine operation according to claim 1, wherein one of said plurality of functions includes a period capture function.

9. The method of controlling engine operation according to claim 1, wherein one of said plurality of functions includes a generate pulse function.

10. The method of controlling engine operation according to claim 1, wherein one of said plurality of functions includes an accumulate period data function.

11. The method of controlling engine operation according to claim 1, wherein one of said plurality of functions includes a transfer working register function.

12. A method for controlling operation of an engine having a crankshaft rotatable through an engine cycle, comprising the steps of:
dividing the engine cycle into a plurality of data groups, each of said plurality of data groups corresponding to a portion of the engine cycle, each of said plurality of data groups corresponding to a table having a series of functions;
detecting a crankshaft position during engine operation; and
performing said series of functions of said data groups when said detected crankshaft position is in a corresponding portion of the engine cycle.

13. The method for controlling engine operation according to claim 12 wherein said table includes a collection of data bits corresponding to said series of functions.

14. The method of controlling engine operation according to claim 12, wherein said engine cycle is defined by 720 degrees of crankshaft rotation.

15. The method for controlling engine operation according to claim 12 wherein each of said plurality of data groups define equal portions of crankshaft rotation.

16. The method for controlling engine operation according to claim 15 wherein said engine cycle is defined by 720 degrees of crankshaft rotation.

17. The method for controlling engine operation according to claim 15 wherein said equal portions of crankshaft rotation is 10 degrees.
